(19) United States
(12) Patent Application Publication
(10) Pub. No.: US 2025/0362378 A1
(43) Pub. Date: Nov. 27, 2025

(54) METHOD OF ESTIMATING DIRECTION OF ARRIVAL (DOA) FOR RADAR SYSTEM

(71) Applicant: Alpha Networks Inc., Hsinchu (TW)

(72) Inventors: Wen-Jiunn TSAY, Hsinchu (TW); Tzong-Shiann YANG, Hsinchu (TW)

(21) Appl. No.: 18/933,858

(22) Filed: Oct. 31, 2024

(30) Foreign Application Priority Data
May 22, 2024 (TW) 113118858

(51) Int. Cl. G01S 7/35; G01S 13/58

(52) U.S. Cl. CPC G01S 7/352; G01S 13/584; G01S 13/588

(57) ABSTRACT

A method of estimating a direction of arrival (DoA) for a radar system includes: for each time slot, one transmitting antenna emitting a transmitted signal, one receiving antenna receiving a reflected signal, a processing unit obtaining an estimated distance based on a duration between signal emission and signal reception, and obtaining a relative speed based on the estimated distance and another estimated distance which was obtained for an immediately prior time slot; in response to performing the above steps at least twice, the processing unit determining whether a stop condition is met; when the stop condition is met, the processing unit setting the relative speed that was most recently obtained as an iterative relative speed and obtaining a compensation phase value based on the iterative relative speed; and the processing unit obtaining the DoA based on the compensation phase value and a distance between two adjacent virtual antennas.

### CROSS-REFERENCE TO RELATED APPLICATION

This application claims priority to Taiwanese Invention Patent Application No. 113118858, filed on May 22, 2024, the entire disclosure of which is incorporated by reference herein.

### FIELD

The disclosure relates to a method of estimating direction of arrival (DoA) for a radar system, and more particularly to a method of estimating DoA for a radar system with relatively higher accuracy by reducing the effect of phase caused by movements of objects.

### BACKGROUND

Radar detection technology is widely used to estimate, for an object in front of a radar system, the distance and angle of the object in relation to the radar system, and the speed of the object relative to the radar system. When the object moves, phase differences of signals received by receiving antennas of the radar system change, resulting in errors in the calculated angle. Therefore, reducing the errors in estimating the angle needs to be addressed.

### SUMMARY

Therefore, an object of the disclosure is to provide a method of estimating DoA for a radar system that can alleviate at least one of the drawbacks of the prior art.

According to the disclosure, a method of estimating a direction of DoA for a radar system is provided. The radar system is used for detecting an object and including a processing unit, a plurality of transmitting antennas and a plurality of receiving antennas.

The method includes steps of, for each time slot, one of the transmitting antennas emitting a transmitted signal which is to be reflected by the object to form a reflected signal, one of the receiving antennas receiving the reflected signal at a current time of reception, the processing unit obtaining an estimated distance based on a duration between a time point at which the transmitting antenna emitted the transmitted signal and a time of reception at which the receiving antenna received the reflected signal, and the processing unit obtaining a relative speed based on the estimated distance and another estimated distance which was obtained for a an immediately prior time slot.

The method further includes steps of: in response to performing the above steps at least twice. the processing unit determining whether a stop condition is met; in response to determining that the stop condition is met, the processing unit setting the relative speed that was most recently obtained as an iterative relative speed; the processing unit obtaining a compensation phase value based on the iterative relative speed; and the processing unit obtaining the DoA based on the compensation phase value and a distance between adjacent two of the receiving antennas.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a flowchart illustrating an embodiment of a method of estimating DoA for a radar system according to the disclosure.

FIG. 2 is a block diagram illustrating the radar system implementing the method of estimating DoA according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

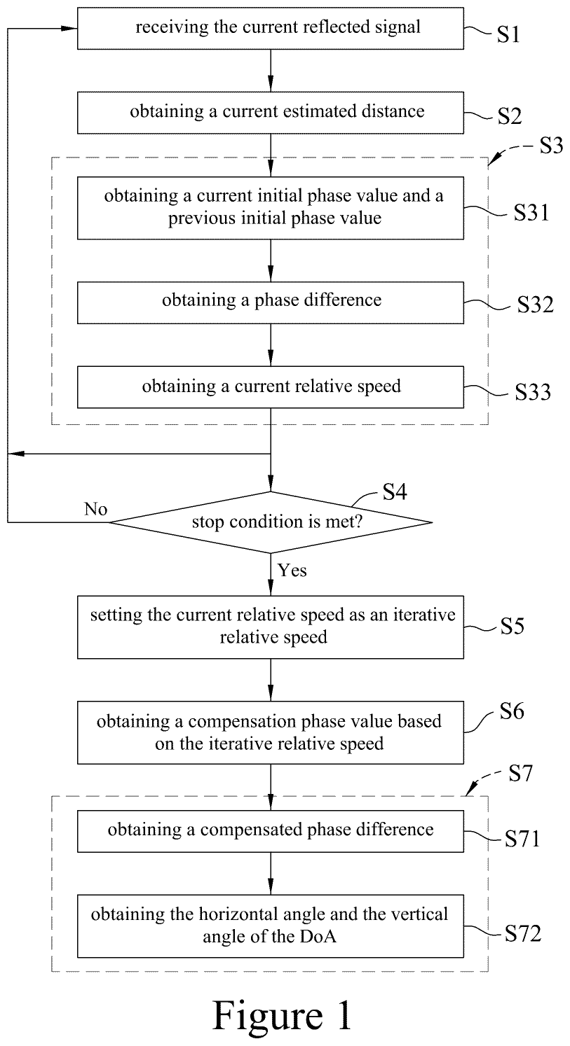

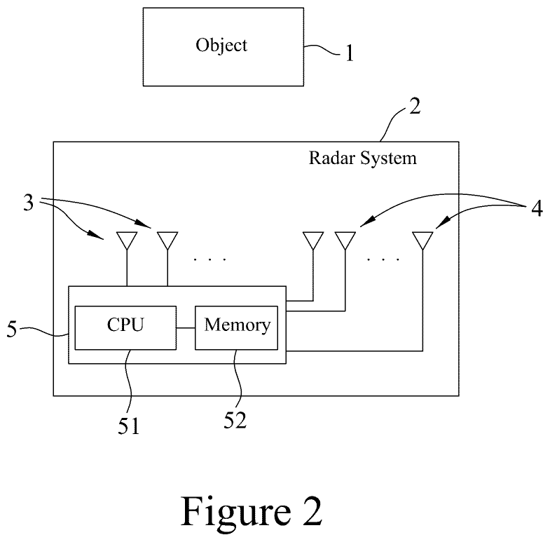

Referring to FIGS. 1 and 2, an embodiment of a method of estimating DoA for a radar system is implemented by a radar system 2. In this disclosure, the radar system 2 is, but not limited to, a time-division multiplexing multi-input multi-output (TDM MIMO) radar system for detecting an object 1 in its vicinity. The radar system 2 includes a processing device 5, a number M of transmitting antennas 3 and a number K of receiving antennas 4. For example, the number M of transmitting antennas 3 and the number K of receiving antennas 4 form an array of virtual antennas arranged in an M×K matrix configuration. In this embodiment, the number M and the number K are both greater than 2; for example, the number M is equal to four, and the number K is equal to nine. The virtual antennas are constructed using signal processing techniques, such that the signals received by the receiving antennas 4 are processed and reconstructed as if they were received by the virtual antennas. In the following, the virtual antenna receiving a signal means that, while the signal is actually received by a physical antenna, it is simulated as being received by the virtual antenna.

The processing device 5 includes a central processing unit (CPU) 51 and a memory 52 electrically connected to the CPU 51. Examples of the CPU 51 includes, for example but not limited to, a single-core processor, a multi-core processor, a dual-core mobile processor, a microprocessor, a microcontroller, a digital signal processor (DSP), a field-programmable gate array (FPGA), an application-specific integrated circuit (ASIC), a radio frequency integrated circuit (RFIC), and the like. The memory 52 may be random access memory (RAM), read-only memory (ROM), programmable ROM (PROM), firmware, and/or flash memory, etc., that store instructions. When the CPU 51 executes these instructions stored in the memory 52, the CPU 51 performs steps S2 to S7 of the following procedure.

Before getting into the details of the method of estimating DoA for a radar system, operations of the transmitting antennas 3 are described first. During each time slot, one of the transmitting antennas 3 emits a transmitted signal which is to be reflected by the object 1 to form a reflected signal. Specifically, during a current time slot, one of the transmitting antennas 3 emits a current transmitted signal which is to be reflected by the object 1 to form a current reflected signal; similarly, during a previous time slot immediately before the current time slot, one of the transmitting antennas 3 emitted a previous transmitted signal which was reflected by the object 1 to form a previous reflected signal. It should be noted that the following steps of the method is performed with respect to the current time slot, and should be implemented with respect to each of the virtual antennas.

In step S1, the current reflected signal is received by the virtual antenna at a current time of reception (T_{b}). It is noted that, for the previous time slot, the previous reflected signal was received by the virtual antenna at a previous time of reception (Tₐ).

In step S2, the CPU 51 obtains a current estimated distance based on a duration between a current emitting time point at which the current transmitted signal was emitted and the current time of reception (T_{b}) at which the current reflected signal was received by the virtual antenna.

Specifically, the CPU 51 calculates the current estimated distance using the following formula:

$$d = \frac{c τ}{2} \qquad ( 1 )$$

where d is the current estimated distance, c is the speed of light, and τ is the duration between the current emitting time point and the current time of reception (T_{b}).

In step S3, the CPU 51 obtains an estimated current relative speed based on the current estimated distance and a previous estimated distance which was obtained for the previous time slot. It is noted that, when the previous reflected signal was received by the virtual antenna at the previous time of reception (Tₐ), the CPU 51 calculated the previous estimated distance then using the formula (1) where d is the previous estimated distance and x is a duration between a previous emitting time point at which the previous transmitted signal was emitted and the previous time of reception (Tₐ).

Specifically, step S3 includes the following sub-steps S31 to S33. In sub-step S31, the CPU 51 obtains a current initial phase value based on the current estimated distance and a wavelength of the current reflected signal, and obtains a previous initial phase value based on the previous estimated distance and a wavelength of the previous reflected signal. The current initial phase value and the previous initial phase value are calculated based on the following formula:

$$ϕ = \frac{4 π d}{λ} , λ = \frac{f}{c} \qquad ( 2 )$$

where ϕ is the current/previous initial phase value, d is the current/previous estimated distance, and f is a frequency of the current/previous reflected signal.

In sub-step S32, the CPU 51 obtains a phase difference based on the current initial phase value and the previous initial phase value using the following formula

$$Δ ϕ = {ϕ}_{b} - {ϕ}_{a} \qquad ( 3 )$$

where ϕ_{b} is the current initial phase value, and ϕₐ is the previous initial phase value.

In sub-step S33, the CPU 51 obtains the current relative speed based on the phase difference and the duration between the current emitting time point and the current time of reception (T_{b}). Specifically, sub-step S33 includes calculating the current relative speed using the following formula:

$$v = \frac{λ Δ ϕ}{2 π {T}_{c}} \qquad ( 4 )$$

where λ is the wavelength of the current reflected signal, Δϕ is the phase difference, and T_{c}=T_{b}−Tₐ.

The above steps (S1-S3) are repeated over time. When two or more relative speeds respectively estimated for two or more successive time slots are obtained (i.e., the CPU 51 has obtained the current relative speed based on the current estimated distance the previous estimated distance, and a previous relative speed based on the previous estimated distance and a further previous estimated distance), then the CPU 51 determines whether a stop condition is met (step S4).

When it is determined that the stop condition is met, the procedure proceeds to step S5, where the CPU 51 sets the current relative speed as an iterative relative speed (v′). When it is determined that the stop condition is not met, the procedure returns to step S1. In the present embodiment, the stop condition is that the difference between the current relative speed and the previous relative speed is less than a threshold, i.e., the estimated relative speed is approaching stabilization. In other embodiments, the stop condition is that the number of repetitions of the above steps (S1-S3) reaches a predetermined number, e.g., 20. In practice, regardless of what the stop condition is, steps S1 to S3 are executed in succession and repeated at least two times.

In step S6, the CPU 51 obtains a compensation phase value based on the iterative relative speed. Specifically, step S6 includes calculating the compensation phase value using the following formula:

$${ϕ}_{d} = \frac{2 π {v}^{′} {T}_{c}}{λ} \qquad ( 5 )$$

where ϕ_{d} is the compensation phase value.

In step S7, the CPU 51 obtains the DoA (including a horizontal angle and a vertical angle) based on the compensation phase value and a distance between adjacent two of the virtual antennas. Step S7 includes the following sub-steps S71 and S72.

In sub-step S71, the CPU 51 obtains a compensated phase difference based on the compensation phase value and an initial phase value set (including an initial horizontal phase value and an initial vertical phase value). Specifically, the CPU 51 calculates a compensated horizontal phase difference Δϕₕ and a compensated vertical phase difference Δϕᵥ, which cooperatively serve as the compensated phase difference, using the following formulas:

$$Δ {ϕ}_{h} = Δ {ϕ}_{h 0} - {ϕ}_{d} \qquad ( 6 )$$

$$Δ {ϕ}_{v} = Δ {ϕ}_{v 0} - {ϕ}_{d} \qquad ( 7 )$$

where Δϕₕ₀ is an initial horizontal phase difference that is the phase difference between the reflected signal received by one of the virtual antennas and the reflected signal received by a horizontally adjacent one of the virtual antennas at the moment the signal arrives, Δϕᵥ₀ is an initial vertical phase difference between the reflected signal received by one of the virtual antennas and the reflected signal received by a vertically adjacent one of the virtual antennas at the moment the signal arrives, and ϕ_{d} is the compensation phase value.

In sub-step S72, the CPU 51 obtains the horizontal angle and the vertical angle of the DoA based on the compensated phase difference, using the following formulas:

$${θ}_{h} = {sin}^{- 1} ( \frac{λ Δ {ϕ}_{h}}{2 π l} ) \qquad ( 8 )$$

$${θ}_{v} = {sin}^{- 1} ( \frac{λ Δ {ϕ}_{v}}{2 π l} ) \qquad ( 9 )$$

where θₕ is the horizontal angle, θᵥ is the vertical angle, and l is the distance between adjacent two of the virtual antennas.

In summary, since the movement of the detected object 1 affects the estimation of the phase difference of reflected signals received by the virtual antenna, the present disclosure calculates the relative speed of the object 1 in an iterative manner until it becomes stable, and compensates for the horizontal phase difference and the vertical phase difference of the reflected signals using that relative speed, and eliminates the speed interference by using the compensated horizontal phase difference and the compensated vertical phase difference. Since the phase difference is compensated for, the phase value of the entire virtual antenna matrix is fairly unaffected by velocity, so a more accurate angle can be calculated.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of estimating a direction of arrival (DoA) for a radar system, the radar system being used for detecting an object and including a processing unit, a number M of transmitting antennas and a number K of receiving antennas forming an array of virtual antennas arranged in an M×K matrix configuration, the method comprising steps of:
for each time slot,
one of the transmitting antennas emitting a transmitted signal which is to be reflected by the object to form a reflected signal, the reflected signal being received at a current time of reception,
the processing unit obtaining an estimated distance based on a duration between a time point at which the transmitted signal was emitted and a time of reception at which the reflected signal was received, and
the processing unit obtaining a relative speed based on the estimated distance and another estimated distance which was obtained for an immediately prior time slot;
in response to performing the above steps at least twice, the processing unit determining whether a stop condition is met;
in response to determining that the stop condition is met, the processing unit setting the relative speed that was most recently obtained as an iterative relative speed;
the processing unit obtaining a compensation phase value based on the iterative relative speed; and
the processing unit obtaining the DoA based on the compensation phase value and a distance between adjacent two of the virtual antennas.

2. The method as claimed in claim 1, wherein the step of obtaining the estimated distance includes calculating the estimated distance using
$$d = \frac{c τ}{2} ,$$
where d is the estimated distance, c is speed of light, and τ is the duration.

3. The method as claimed in claim 1, wherein for a current time slot, one of the transmitting antennas emits a current transmitted signal which is to be reflected by the object to form a current reflected signal; for a previous time slot immediately before the current time slot, one of the transmitting antennas emitted a previous transmitted signal which was reflected by the object to form a previous reflected signal; and
wherein for the current time slot, the step of obtaining the relative speed includes:
obtaining a current initial phase value based on the estimated distance obtained for the current time slot and a wavelength of the current reflected signal, and obtaining a previous initial phase value based on the estimated distance obtained for the previous time slot and a wavelength of the previous reflected signal;
obtaining a phase difference based on the current initial phase value and the previous initial phase value; and
obtaining the relative speed based on the phase difference and the duration.

4. The method as claimed in claim 3, wherein obtaining the current initial phase value and the previous initial phase value is to calculate each of the current initial phase value and the previous initial phase value based on
$$ϕ = \frac{4 π d}{λ} ,$$
where
$$d = \frac{c τ}{2} , λ = \frac{f}{c} ,$$
ϕ represents the current initial phase value or the previous initial phase value, c is speed of light, τ is the duration, and d represents the estimated distance obtained for the current time slot and f represents a frequency of the current reflected signal when the current initial phase value is being calculated, and d represents the estimated distance obtained for the previous time slot and f represents a frequency of the previous reflected signal when the previous initial phase value is being calculated.

5. The method as claimed in claim 3, wherein the step of obtaining the phase difference includes calculating the phase difference using
$$Δ ϕ = {ϕ}_{b} - {ϕ}_{a} ,$$
where ϕ_{b} is the current initial phase value and ϕₐ is the previous initial phase value.

6. The method as claimed in claim 3, wherein, for the current time slot, the step of obtaining the relative speed includes calculating the relative speed using
$$v = \frac{λ Δ ϕ}{2 π {T}_{c}} ,$$
where λ is the wavelength of the current reflected signal, Δϕ is the phase difference, T_{c}=T_{b}−Tₐ, T_{b} is a current time of reception at which the receiving antenna received the current reflected signal, and Tₐ is a previous time of reception at which the receiving antenna received the previous reflected signal.

7. The method as claimed in claim 1, wherein for a current time slot, one of the transmitting antennas emits a current transmitted signal which is to be reflected by the object to form a current reflected signal; for a previous time slot immediately before the current time slot, one of the transmitting antennas emitted a previous transmitted signal which was reflected by the object to form a previous reflected signal; and
wherein the step of obtaining the compensation phase value includes calculating the compensation phase value using
$${ϕ}_{d} = \frac{2 π {v}^{′} {T}_{c}}{λ}$$
where ϕ_{d} is the compensation phase value, v′ is the iterative relative speed, T_{c}=T_{b}−Tₐ, T_{b} is a current time of reception at which the current reflected signal is received, Tₐ is a previous time of reception at which the previous reflected signal was received, and λ is the wavelength of the current reflected signal.

8. The method as claimed in claim 1, wherein the step of obtaining the DoA includes sub-steps of:
obtaining a compensated phase difference based on the compensation phase value and an initial phase value set, and
obtaining the DoA based on the compensated phase difference.

9. The method as claimed in claim 8, wherein the sub-step of obtaining the compensated phase difference includes calculating a compensated horizontal phase difference Δϕₕ and a compensated vertical phase difference Δϕᵥ using following formulas:
$$Δ {ϕ}_{h} = Δ {ϕ}_{h 0} - {ϕ}_{d} ,$$
$${Δϕ}_{v} = Δ {ϕ}_{v 0} - {ϕ}_{d} ,$$
where Δϕₕ₀ is an initial horizontal phase difference that is the phase difference between the reflected signal simulated to be received by one of the virtual antennas and the reflected signal simulated to be received by a horizontally adjacent one of the virtual antennas at the moment the reflected signal arrives, Δϕᵥ₀ is an initial vertical phase difference between the reflected signal simulated to be received by one of the virtual antennas and the reflected signal simulated to be received by a vertically adjacent one of the virtual antennas at the moment the reflected signal arrives, ϕ_{d} is the compensation phase value; and
wherein the compensated horizontal phase difference and the compensated vertical phase difference cooperatively serve as the compensated phase difference.

10. The method as claimed in claim 9, wherein the sub-step of obtaining the DoA based on the compensated phase difference includes calculating a horizontal angle and a vertical angle using following formulas:
$${θ}_{h} = {sin}^{- 1} ( \frac{λ Δ {ϕ}_{h}}{2 π l} ) ,$$
$${θ}_{v} = {sin}^{- 1} ( \frac{λ Δ {ϕ}_{v}}{2 π l} ) ,$$
where θₕ is the horizontal angle, θᵥ is the vertical angle, l is the distance between adjacent two of the virtual antennas; and
wherein the horizontal angle and the vertical angle serve as the DoA.
